(19) United States
(12) Patent Application Publication
(10) Pub. No.: US 2002/0111899 A1
(43) Pub. Date: Aug. 15, 2002

(54) On-site computer networking method and system for wine selection and sharing

(76) Inventors: Dennis Veltre, Queens, NY (US); Joan Veltre, Queens, NY (US)

Correspondence Address: Law Office of Richard B. Klar, Suite 2301, 875 Avenue of the Americas, New York, NY, 10001, US

(21) Appl. No.: 10/071,403

(22) Filed: Feb. 8, 2002

Related U.S. Application Data
(60) Provisional application No. 60/267,792, filed on Feb. 9, 2001.

(51) Int. Cl. G06F 17/60

(52) U.S. Cl. 705/37

(57) ABSTRACT

The present invention relates to a method and system for selecting a wine either alone or on a shared basis at a site location such as a restaurant by an auction process at the site through an on line system local to the site. The present invention permits a diner at a restaurant to order a beverage such as a bottle of wine, to be served to the diner in its entirety or a shared basis with others.

### RELATED APPLICATIONS

This is a non- provisional application of a provisional application Serial No. 60/267,792 by Dennis Veltre and Joan Veltre filed Feb. 9, 2001. This is a continuation of provisonal application Serial No. 60/267,792 filed on Feb. 9, 2001 and claims the benefit under section 119(e).

### BACKGROUND OF THE INVENTION

Wine has been enjoyed for thousands of years. However, within the recent past many high-quality, expensive wines have been introduced into the market. At the same time good quality value priced wines have been difficult to find. This is very apparent in restaurants where premium wines are rarely offered to customers by the glass or in half bottles. Consumers may choose to consume less than a full bottle for a variety of reasons: a) dining alone, especially people who travel as part of their job; b) couples may want different types of wine, one person prefers red and the other white; or c) a patron may want to sample several wines with his/her meal.

Unfortunately, there are not many restaurants that can accommodate these people. An article written by William Grimes in the “Dining Out” section of the New York Times indicate that vineyards are reluctant to offer premium wines in half bottles because of the additional cost involved and because of the belief that the wine will experience an accelerated aging process. In the final analysis, the consumer who dines out needs an alternative to inexpensive, poor quality wines.

### SUMMARY OF THE INVENTION

The present invention relates to a method and system for selecting a wine either alone or on a shared basis at a site location such as a restaurant by an auction process at the site through an on line system local to the site. In particular, the present invention provides a method and a system that permits a diner at a restaurant to order a beverage such as a bottle of wine, to be served to the diner in its entirety or a shared basis with others.

The present invention provides a method and a system for selecting wine or any other beverage at a restaurant through an online system for “bidding” at a restaurant.

The present invention provides a method and system for “bidding” on a share of a beverage such as a bottle of wine at a restaurant through an online system- preferably an intranet system which is networked to handheld computer devices at the dining site such as a restaurant.

The present invention provides an online selection guide which offers diners at a restaurant a recommendation of a wine for the meal or meal course that is selected.

The other features of the present invention will become apparent from the foregoing description and accompanying drawings.

### BRIEF DESCRIPTION OF THE DRAWING

FIG. 1 is a screen of a first page illustrating the method and system of the present invention;

FIG. 2 is a screen of another page illustrating the method and system of the present invention;

FIG. 3 is a screen of another page illustrating the method and system of the present invention;

FIG. 4 is a screen of another page illustrating the method and system of the present invention; and

FIG. 5 is a screen of another page illustrating the method and system of the present invention.

### DETAILED DESCRIPTION OF THE PREFERRED EMBODIMENTS

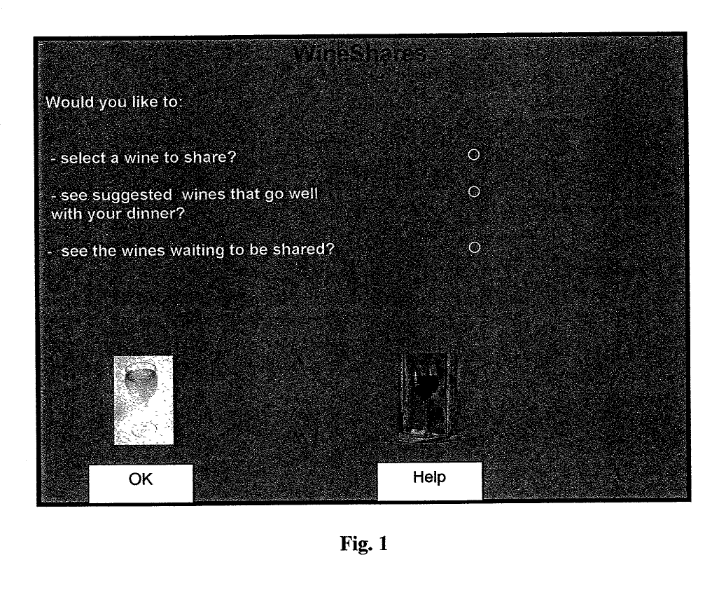

Referring now to the drawings, FIGS. 1-5 illustrate the method and system of the present invention.

When a patron or a diner enters a restaurant to dine, the patron can be handed a commercially available hand held or a palm computer, either when seated and ready to order his/her meal or if there is a waiting period before the patron is seated at the table and perhaps is seated at the bar, he/she could be presented with this palm computer. The present invention will display a first page (FIG. 1) on the screen of the hand held computer which will permit the patrons to:

a) select a wine to share with another patron/table

b) see suggested wines that complement your selections for appetizers and entrees

c) see the wines that are waiting to be shared.

Thus the present invention provides an intranet system which permits patrons at a site location, such as a restaurant, to participate in selecting, e.g. bidding on a wine as a whole bottle or for a share.

If the patron chooses to select a wine to share with another patron, the wine is then put up for a “bid”. In one embodiment of the present invention no auctioning takes place based upon price. A time limit and the ability to taste truly outstanding wines are the stimuli for patrons to submit their bids at the asking price early. In another embodiment the present invention require patrons to bid a at least a minimum amount for the beverage selected and then during the predetermined time interval bidding among patrons either for a share or for exclusive ownership of that beverage , e.g. bottle of wine takes place on the networked computer system at the restaurant.

Given the opportunity to taste several premium wines by the glass the patron has an incentive to “bid” on as many wines as possible but must specify the maximum number of wines that she/he will ultimately select.

The wines offered for auction will have a time limit (e.g. 10 minutes) before no more bids are accepted on the system of the present invention. Bids will be selected on a first come/first serve basis). If a patron selects two or more wines, he/she will be given the choice to accept either wine or both wines before these wines could be shared.

Once the wine has been offered for bid, all patrons have the opportunity to select the wine. In an ideal environment, each table would have a hand help PC at its disposal. In other environments, a centralized board would show all of the wines on auction, with the time remaining to select for each wine. This approach would be more appropriate for “theme” restaurants such as Michael Johnson's Steakhouse in Grand Central Station in New York City.

Once a “bid” has been accepted, the wine is then pulled by the restaurant from stock and poured into 2 identical decanters in view of both patrons, if possible, to show that each table received the same amount. These decanters will be preferably marked with the exact amount for approximately 375 mm. In older wines, there may be times when there is less than 750 mm in a bottle. In those cases, an equal amount will be poured into each decanter.

The centralized board showing the status of the wine auction may be tailored to the theme or motif of the restaurant. For example, many historic train stations have been converted into restaurants. The natural extension of this theme is to have a board similar to those found in the major train terminals such as Union Station or Grand Central Station. A sports bar could have a scoreboard with the wines that are near the expiration of the time highlighted as a “two minute warning”.

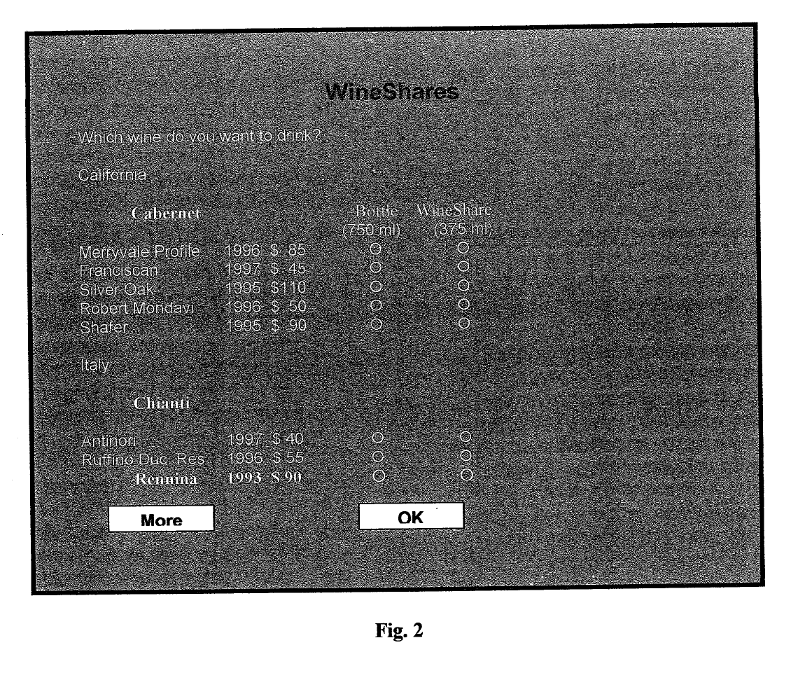

The patron, of course can select an available wine from a menu selection on a screen (FIG. 2). This page gives the patron the option of putting in a “bid” for the selected wine in its entirety or as a share as was discussed above. The bid is submitting a selection for the wine during the time period. The price for the selection is fixed. It is merely a question of ordering it before the time limit and quantity in stock at the restaurant expires.

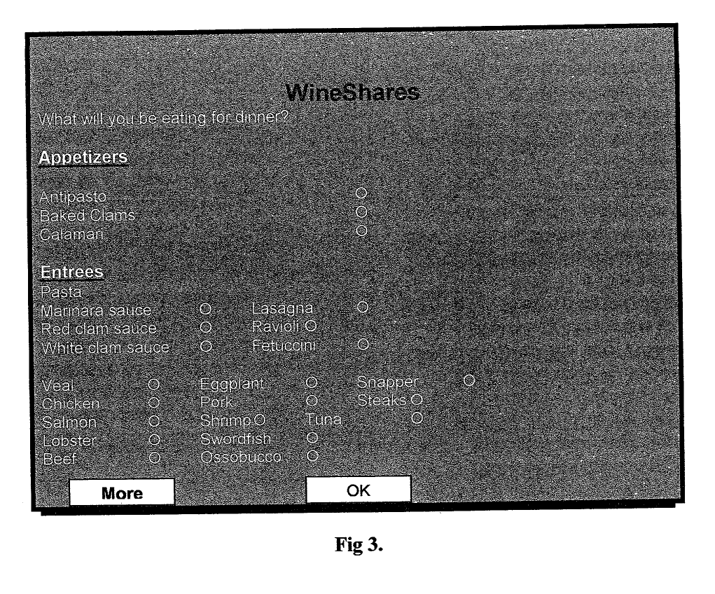

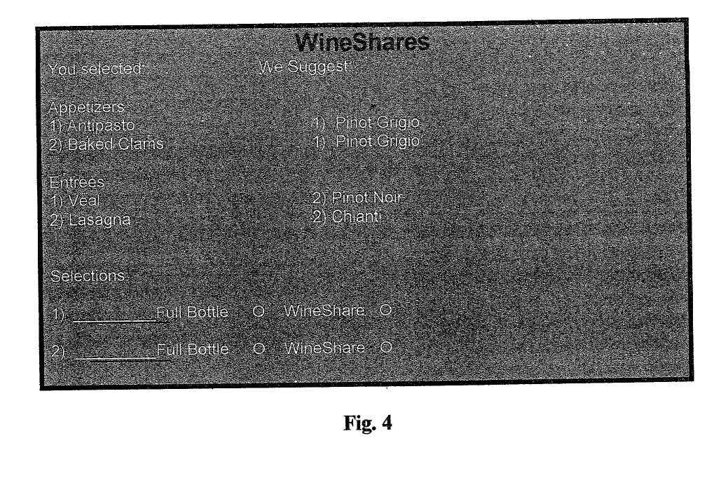

Another feature of the present invention is that it provides the option to assist the patron with the selection of an appropriate wine with the dinner selected by the patron. As can be seen in FIG. 1 the patron can select the option from the menu of suggested wines that go well with the patron's dinner. FIG. 3 provides a menu of having the patron describe his meal selection to determine the appropriate wine for a particular course of the meal. FIG. 4 then suggests the appropriate wine to complement the selected meal course, e,g, the main course or a dessert wine with dessert. This feature would be equally appealing to all patrons regardless of the size of the dinner party and is independent of the feature of sharing wines as it is not necessary to share wines when selecting this feature although both features can be selected and are available if desired with the present invention.

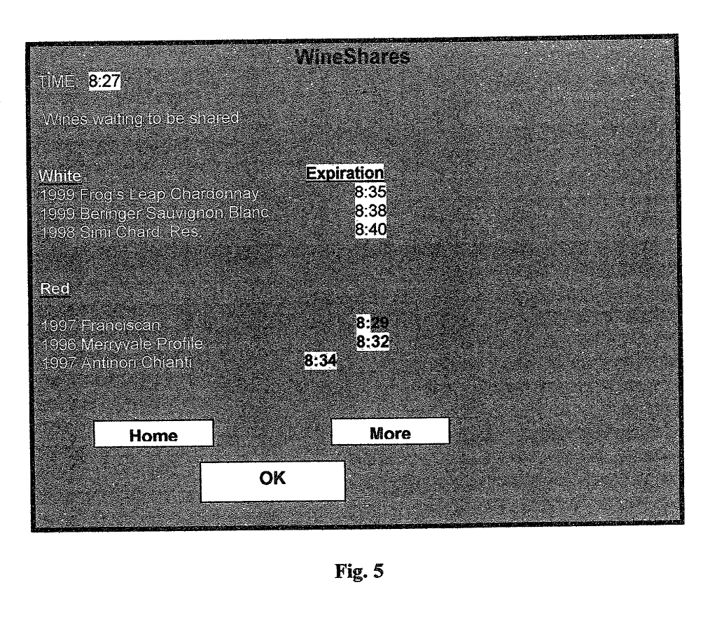

FIG. 5 illustrates how the present invention provides a screen menu for indicating the number wines that have been selected by a patron and is available for a wine share and the amount of time left for a patron to join in on a wine share with the time remaining preferably displayed blinking on screen.

Often a patron will request a wine with which he/she is familiar but may not be appropriate for the food being considered. This application would enable the patron to select a wine based upon the appetizers and entrees being ordered. In a sense, this option would provide an on line sommelier type service in restaurants without the need for an actual one.

A database that pairs food and wine types with recommended selections would be included in the base product. For example, grilled chicken will get paired with chardonnay or Chianti. The patron would then determine if a full bottle would be satisfactory or if half bottle would suffice. It is possible that two half bottles were selected, one for an appetizer and one for an entree. In such a case, the application of the present invention would need to determine if both conditions need to be met before the wine sharing could take place as described above.

While the package would have the standard food parings, the restaurant would be able to develop its own wine-food pairing database using its menu and/or specials.

The wine database would contain all of the pertinent information about the wine: Winery, varietal, vintage, price. It would also contain an optional inventory status and locator, food pairing suggestions to the individual restaurant's menu and reviews from various authorities such as Parker or the Wine Spectator.

If the inventory status option is deployed an inventory control program would be available to update inventories. A hand held scanner, such as Symbol or Monarch could be used to perform these updates easily and quickly.

In addition to sharing wines, diners could also use this application for sharing meals normally prepared for two such as Peking Duck, Chateaubriand and Rack of Lamb.

In addition to restaurants, the present invention can be used for several other venues.

Hotels offer a the largest number of single diners of any venue. Many business travelers opt to dine in the hotel restaurant or utilize room service. The present invention would enable individuals, traveling on expense accounts, to order fine wines in manageable quantities. In this environment, the palm computers would be used in the restaurant but would not be necessary for room service. The technology that is commonly in place for ordering movies and video games could also be used to select a wine to share with another diner ordering room service.

All international flights and long distance domestic flights would also be suitable environments for using the present invention. These flights often are equipped with telephones that may be used for email, ordering duty free items and checking stock quotes. This same technology could be used for selecting wines. These carriers will allow guests to order fine wines but do not accommodate couples who have different preferences. The present invention would give numerous choices to hundreds of individuals dining at specified times which is customary on these cruises.

The Internet continues to provide a convenient means to research restaurants and make dinner reservations. This application could easily be extended to the internet whereby the diner would view the menu and wine list and request a WineShare at the same time.

Passengers already reserve limousines and car service via the Internet. Business travelers, particular, travel to the same locations at the same time: airports. This application could allow the passengers to “trade up” to a more comfortable and plush vehicle if they could share a ride.

The hardware at the tables in the restaurant would be any handheld PC that operates on a Pocket PC or Palm OS. Leading brands are Palm, Casio, Hewlett-Packard and Compaq.

The back office hardware is a Pentium III (400 Mhz or higher with 64 MB RAM) The operating systems are Windows 95, 98 or 2000 or NT 4.0 system.

It is to be understood that the above described embodiments of the invention are merely illustrative of the principles thereof and that numerous embodiments may be derived within the spirit and scope thereof.

1. A method for selecting a beverage through an online site computer network, the steps comprising:
posting a selection of beverages available at a site for consumption on either an exclusive basis or a shared basis on a computer network local to said site at locations throughout the site where patrons are situated during a predetermined time interval;
permitting each of said patrons at said site to select at least one beverage on an exclusive or shared basis from said posted selection by hand held computer units networked to said system;
displaying said selections available based on stock and share selections from patrons so that other patrons can join in any of the shared selections and displaying the amount of time remaining in said predetermined time interval before said selection process is terminated by the computer network.

2. The method according to claim 1 wherein said beverage is wine.

3. The method according to claim 1 wherein said site is a restaurant.

4. The method according to claim 2 further comprising the step of permitting each of said patrons to select meal courses through said computer network and having the computer network recommend a suitable wine or wines for said selected meal courses.

6. The method according to claim 1 further comprising the step of during said selection of said at least one beverage permitting each of said patrons along with said selection of said at least one beverage to submit a bid for a price that is at least as much as a minimum price posted by the system for the selected beverage on either an exclusive or shared basis and permitting other patrons to bid for said selected beverage on either an exclusive or shared basis and posting bids as submitted until the predetermined time interval expires and at the end of said predetermined time interval said selected beverage is awarded to said highest bid or bids for shared bidders.

7. A system for selecting a beverage through an online site computer network, comprising:
a computer network local to said site including hand held computer units located throughout the site at locations where patrons are situated for posting a selection of beverages available at a site for consumption on either an exclusive basis or a shared basis;
menu selections one each of said networked hand held computer unit to permit each of said patrons at said site to select at least one beverage on an exclusive or shared basis from said posted selection by said system;
display means for displaying at said site said selections available based on stock and share selections from patrons so that other patrons can join in any of the shared selections and for displaying the amount of time remaining in said predetermined interval before said selection process is terminated by the computer network.

8. The system according to claim 7 wherein said beverage is wine.

9. The system according to claim 7 wherein said site is a restaurant.

10. The system according to claim 7 further comprising menu selections on each of said networked hand held computer units to permit each of said patrons to select meal courses through said computer network and having the computer network recommend a suitable wine or wines for said selected meal courses.

11. The method according to claim 7 further comprising menu selections, during said selection of said at least one beverage, for, along with said selection of a beverage by said one of said patrons, submitting a bid for a price that is at least as much as a minimum price posted by the system for said selected beverage on either an exclusive or shared basis and for permitting other patrons to bid for said selected beverage on either an exclusive or shared basis and posting bids as submitted until the predetermined time interval expires and at the end of said predetermined time interval said selected beverage is awarded to said highest bid or bids for shared bidders.
